(19) United States
(12) Patent Application Publication
(10) Pub. No.: US 2015/0088525 A1
(43) Pub. Date: Mar. 26, 2015

(54) METHOD AND APPARATUS FOR CONTROLLING APPLICATIONS AND OPERATIONS ON A TERMINAL

(71) Applicant: Tencent Technology (Shenzhen) Co., Ltd., Shenzhen (CN)

(72) Inventors: Yi Shan, Shenzhen (CN); Li Lu, Shenzhen (CN); Hui Tang, Shenzhen (CN)

(21) Appl. No.: 14/490,209

(22) Filed: Sep. 18, 2014

Related U.S. Application Data
(63) Continuation of application No. PCT/CN2014/077534, filed on May 15, 2014.

(30) Foreign Application Priority Data
Sep. 24, 2013 (CN) 2013104384735

(51) Int. Cl. G10L 17/22; G10L 15/22

(52) U.S. Cl. CPC G10L 17/22; G10L 15/22; G10L 2015/223
USPC 704/275

(57) ABSTRACT

A method and apparatus for controlling an application startup and its functions on a terminal have been disclosed. The method including: acquiring a first speech data input by a user, wherein speech recognition is being performed on the first speech data to obtain a first speech recognition result; determining whether the first speech recognition result includes a startup command word for a particular installed application which has not been started on a terminal, wherein the particular installed application includes at least a social networking application; if the first speech recognition result includes the startup command word for the particular installed application, then the particular installed application is regarded as a controlled application, and the startup command word is converted into a startup command for the controlled application; and starting the controlled application utilizing the startup command of the controlled application.

### CROSS-REFERENCE TO RELATED APPLICATIONS

The application is a continuation of PCT Application No. PCT/CN2014/077534, filed on May 15, 2014, which claims priority to Chinese Patent Application No. 2013104384735, filed on Sep. 24, 2013, which is incorporated by reference in their entireties.

### FIELD OF THE TECHNOLOGY

The disclosure belongs to the field of Information Processing technology; to a method and apparatus for controlling applications and operations on a terminal.

### BACKGROUND

With the rapid development of information technology, users are increasing relying on various social networking web applications installed on a mobile terminal (i.e., smart phones, mobile tablet devices, laptop computers, desk top computers, etc.) to stay connected to family members, friends and people and to access information on the Internet. Such social network web applications may include social networking web applications (offered by companies such as AOL, Yahoo, Google, MSN, Tencent, Facebook, Skype, etc., to name a few) which may offer instant messaging (IM) services for real-time online chat, voice over IP chat or video chat. Some may offer message blogging, comments posting and email services.

Even though the above mentioned social networking applications may be developed to be run on mobile terminals with start-up icons and commands tool bars to facilitate fast operations and easy functions selections, the initiation and operation commands of the social networking applications, nevertheless, are still manually performed by the user.

For example, the manual operations may be performed by using a peripheral device such as a mouse or stylus, alternately, the manual operations may be performed using a finger to tap on an application icon on a touch screen display to invoke an application. For operations command, a user may need to type in a message using a keyboard, alternately typing on an on-screen touch sensitive keyboard or dragging and tapping on a touch screen function tool bar to select a command or to complete an operation. Such manual operations, nevertheless, still require user's eyes and fingers coordination.

During the course of implementing the present disclosure, the user may be in an environment (e.g., driving, simultaneously operating another equipment) or engaged in an activity whose hands, eyes or fingers may not be free up to carry out the manual operations to start an application or to process the operations to input contents or to read received contents generated by the application. Alternately, the terminal may be out of reach from the user or the user may simply have a physical handicap which may restrict or prevent manual operations to start or operate an application on the mobile terminal.

### SUMMARY

An embodiment of the present disclosure has provided a method for controlling an application start up and its operations, the method including: acquiring a first speech data input by a user, wherein speech recognition is being performed on the first speech data to obtain a first speech recognition result; determining whether the first speech recognition result includes a startup command word for a particular installed application which has not been started on a terminal, wherein the particular installed application includes at least a social networking application; if the first speech recognition result includes the startup command word for the particular installed application, then the particular installed application is regarded as a controlled application, and the startup command word is converted into a startup command for the controlled application; starting the controlled application utilizing the startup command of the controlled application.

Another embodiment of the disclosure discloses an apparatus for controlling an application startup and its functions, which includes at least a processor operating in conjunction with at least a memory which stores instruction codes operable as plurality of modules, wherein the plurality of modules may include: a first acquisition module which acquires a first speech data; a first recognition module which performs speech recognition on the first speech data in order to obtain a first recognition result; a first determining module which determines whether the first speech recognition result includes a startup command word for a particular installed application which has not been started on a terminal, wherein the particular installed application includes at least a social networking application; a first conversion module, which: if it is determined by the first determining module that the first speech recognition result includes the startup command word for the particular installed application has not been started, sets the particular installed application as a controlled application; and converts the startup command word included in the first speech recognition result into a startup command of the controlled application, a starting module which starts the controlled application utilizing the startup command of the controlled application.

Another embodiment of the disclosure discloses a non-transitory computer-readable medium having stored thereon, a computer program having at least one code section being executable by a machine which causes the machine to perform steps for controlling an application startup and its functions, including: acquiring a first speech data input by a user, wherein speech recognition is being performed on the first speech data to obtain a first speech recognition result; determining whether the first speech recognition result includes a startup command word for a particular installed application which has not been started on a terminal, wherein the particular installed application includes at least a social networking application; if the first speech recognition result includes the startup command word for the particular installed application, then the particular installed application is regarded as a controlled application, and the startup command word is converted into a startup command for the controlled application; starting the controlled application utilizing the startup command of the controlled application.

By implementing the embodiment of the present disclosure, a hands-free speech control interaction with the terminal to startup an application, to perform functions and process input and output to and from the application, thus providing faster and simpler ways to use an application which enhances user's experience.

### BRIEF DESCRIPTION OF THE DRAWINGS

The accompanying drawings are included to provide a further understanding of the claims and disclosure, are incorporated in, and constitute a part of this specification. The detailed description and illustrated embodiments described serve to explain the principles defined by the claims.

FIG. 1 is an exemplary flowchart illustrating a method for controlling an application and its operations in a terminal, according to an embodiment of the disclosure.

FIG. 2 is an exemplary flowchart illustrating a method for controlling an application and its operations in a terminal, according to another embodiment of the disclosure.

FIG. 3 illustrates an exemplary structural schematic diagram of an apparatus for controlling an application and its operations, according to a first embodiment of the disclosure.

FIG. 4 illustrates an exemplary structural schematic diagram of an apparatus for controlling an application and its operations, according to a second embodiment of the disclosure.

FIG. 5 illustrates an exemplary structural schematic diagram of an apparatus for controlling an application and its operations, according to a third embodiment of the disclosure.

FIG. 6 illustrates an exemplary variant structural schematic diagram of an apparatus as depicted in FIG. 5, according to another embodiment of the disclosure.

FIG. 7 illustrates an exemplary variant structural schematic diagram of an apparatus as depicted in FIG. 6, according to yet another embodiment of the disclosure.

FIG. 8 illustrates an exemplary variant structural schematic diagram of an apparatus as depicted in FIG. 7, according to yet another embodiment of the disclosure.

FIG. 9 illustrates an exemplary variant structural schematic diagram of an apparatus as depicted in FIG. 8, according to yet another embodiment of the disclosure.

FIG. 10 illustrate an exemplary structural schematic diagram of a terminal, according to an embodiment of the disclosure.

### DETAILED DESCRIPTION OF THE EMBODIMENTS

The various embodiments of the present disclosure are further described in details in combination with attached drawings and embodiments below. It should be understood that the specific embodiments described here are used only to explain the present disclosure, and are not used to limit the present disclosure. In addition, for the sake of keeping description brief and concise, the newly added features, or features that are different from those previously described in each new embodiment will be described in details. Similar features may be referenced back to the prior descriptions in a prior numbered drawing or referenced ahead to a higher numbered drawing.

In order to clarify the object, technical scheme and advantages of the present disclosure more specifically, the present disclosure is illustrated in further details with the accompanied drawings and embodiments. It should be understood that the embodiments described herein are merely examples to illustrate the present disclosure, not to limit the present disclosure.

The present disclosure provides a method for controlling application startup, which is suitable for startup control for any application, especially for social networking applications on terminals. The terminal includes but not limited to smart mobile phones, PCs and tablets etc. Whenever it becomes inconvenient for a user to manually control and startup one or more applications which have been installed on the terminals, the disclosure provides a method for controlling startup and operations as provided in the embodiments startup via speech control, thus and improving convenience for startup and controlling applications.

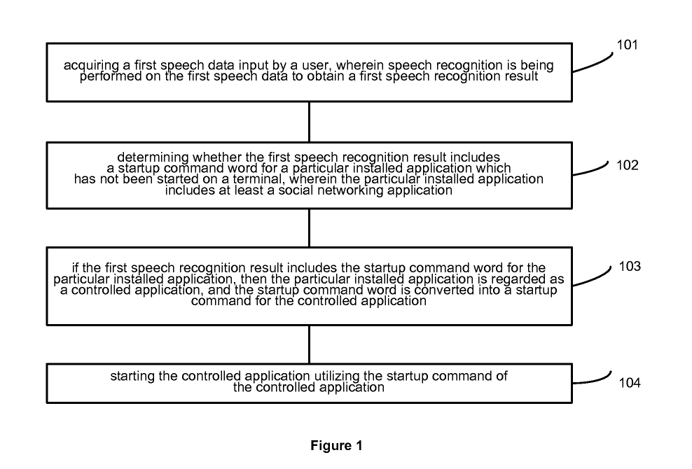

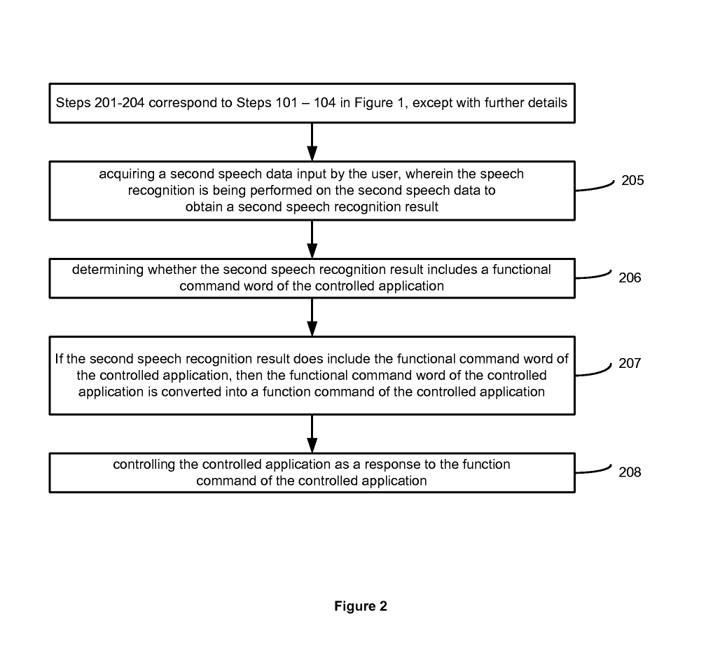

FIG. 1 is an exemplary flowchart illustrating a method for controlling an application and its operations in a terminal, according to an embodiment of the disclosure. The method includes the following exemplary steps:

Step 101: acquiring a first speech data input by a user, wherein speech recognition is being performed on the first speech data to obtain a first speech recognition result.

Step 102: determining whether the first speech recognition result includes a startup command word for a particular installed application which has not been started on a terminal, wherein the particular installed application includes at least a social networking application.

Furthermore, prior to the determining of whether the first speech recognition result includes the startup command word for the particular installed application, the method further include: setting and storing a startup command word of each installed application on the terminal; wherein the determining of whether the first speech recognition result includes the startup command word for the particular installed application which has not been started on the terminal, include: comparing the first recognition result with the stored startup command word of each installed application on the terminal, if the first speech recognition result includes the startup command word of the particular installed application which has not been started, then the first speech recognition result is determined to include the startup command word of the particular installed application.

Step 103: if the first speech recognition result includes the startup command word for the particular installed application, then the particular installed application is regarded as a controlled application, and the startup command word is converted into a startup command for the controlled application; and starting the controlled application utilizing the startup command of the controlled application.

Furthermore, prior to converting the startup command word into the startup command for the controlled application, the method performing: setting and storing a correspondence between the startup command and the startup command word for each installed application; wherein the converting of the startup command word into the startup command of the controlled application, including: looking up the startup command corresponding to the startup command word of the controlled application in the stored correspondence between the startup command and the startup command word of each installed application, in order to obtain the startup command of the controlled application.

Step 104: starting of the controlled application utilizing the startup command of the controlled application.

Furthermore, after the starting of the controlled application utilizing the startup command of the controlled application, the method further includes: acquiring a second speech data input by the user, wherein the speech recognition is being performed on the second speech data to obtain a second speech recognition result; determining whether the second speech recognition result includes a functional command word of the controlled application; If the second speech recognition result does include the functional command word of the controlled application, then the functional command word of the controlled application is converted into a function command of the controlled application; controlling the controlled application as a response to the function command of the controlled application.

Furthermore, prior to the determining of whether the second speech recognition result includes the functional command word for the controlled application, the method also includes: setting and storing a functional command word for each of the installed application; wherein the determining of whether the second speech recognition result includes the functional command word of the controlled application, including: comparing the second speech recognition result with the functional command word of the controlled application, and determining whether the second speech recognition result includes the functional command word of the controlled application according to the comparison result.

Furthermore, prior to the converting of the functional command word of the controlled application into the function command of the controlled application, the method includes: setting and storing a correspondence between the function command and a functional command word of each installed application; wherein the converting of the functional command word into the function command of the controlled application, includes: looking up the function command corresponding to the functional command word of the controlled application in the stored correspondence between the function command and the functional command word of the controlled application in order to obtain the function command of the controlled application.

Furthermore, after the starting of the controlled application utilizing the startup command of the controlled application, the method includes: receiving as an input from another user, a text data pertaining to the controlled application; converting the text data pertaining to the controlled application into a corresponding speech data utilizing text to speech conversion; and playing to the user the converted speech data as an audible signal, wherein the performing of the speech recognition may include utilizing speech to text conversion.

FIG. 2 is an exemplary flowchart illustrating a method for controlling an application and its operations in a terminal, according to another embodiment of the disclosure. The embodiment of FIG. 2 is a continuation of FIG. 1 for steps 101-104. Further details may be described for the corresponding steps 101-104

In step 201: acquiring a first speech data input by a user, wherein speech recognition is being performed on the first speech data to obtain a first speech recognition result. For this step, the specific implementation for acquiring the first speech data includes but not limited to: detecting the initiation and termination endpoint of the first speech spoken by the user; acquiring the speech data between the initiation endpoint and termination endpoint, and taking the obtained speech data as the first speech data.

For example, the detected initiation endpoint of the first speech may be regarded as 10:00:00, the termination endpoint as 10:00:05, the speech data lasting 5 seconds between 10:00:00 and 10:00:05 may be regarded as the obtained first speech data. It is important to note that other method for acquiring the speech data may be adopted. The above-mentioned method for acquiring the first speech data may implement known and available speech to text conversion or voice to text conversion software, which would be beyond the scope of the disclosure.

In addition, the specific implementation for recognizing the first speech data includes but not limited to: recognizing the first speech data by adopting background acoustic model and foreground acoustic model. Wherein, background acoustic model adopts LVCSR (Large Vocabulary Continuous Speech Recognition) based Mono-phone technology, while foreground acoustic model adopts Tri-phone technology from LVCSR, through building acoustic resources in advance on the server by decoding network. The acoustic resources may include a correspondence table between various speech feature vector and corresponding command characters. Spectrum transform may be executed on the first speech data before the speech recognition to obtain the corresponding speech feature vector, and looking up the command characters corresponding to the speech feature vector in the acoustic resources which is built in advance, the command characters are to be defined as the first speech recognition result.

Of course, other speech recognition methods may be adopted except the above-mentioned method for recognizing the first speech data, which will not be specifically limited by the embodiment.

Step 202: determining whether the first speech recognition result includes a startup command word for a particular installed application which has not been started on a terminal, wherein the particular installed application includes at least a social networking application.

For this step, in order to achieve controlling an application startup via speech, the method provided in the present embodiment may set corresponding startup command words for various applications on mobile terminals, so as to compare the first recognition result respectively with the startup command words of various applications, so that it may determine whether the first speech recognition result may include the startup command word of the application which has been installed but not yet started, i.e. determining whether or not to start the application which is installed but not started. Therefore, before determining whether the first speech recognition result includes a startup command word for the application which is to be started, the step may also include: setting and storing a startup command word of each installed application.

Due to a variety of applications may have been installed on a mobile terminal, in order to differentiate which application is to be started, it may be required to set a respective command word for each corresponding installed application. Using a social networking application, such as an instant messaging (IM) application as an example, a startup command word of the instant messaging application may be set as a key field, such as “starting instant messaging application”.

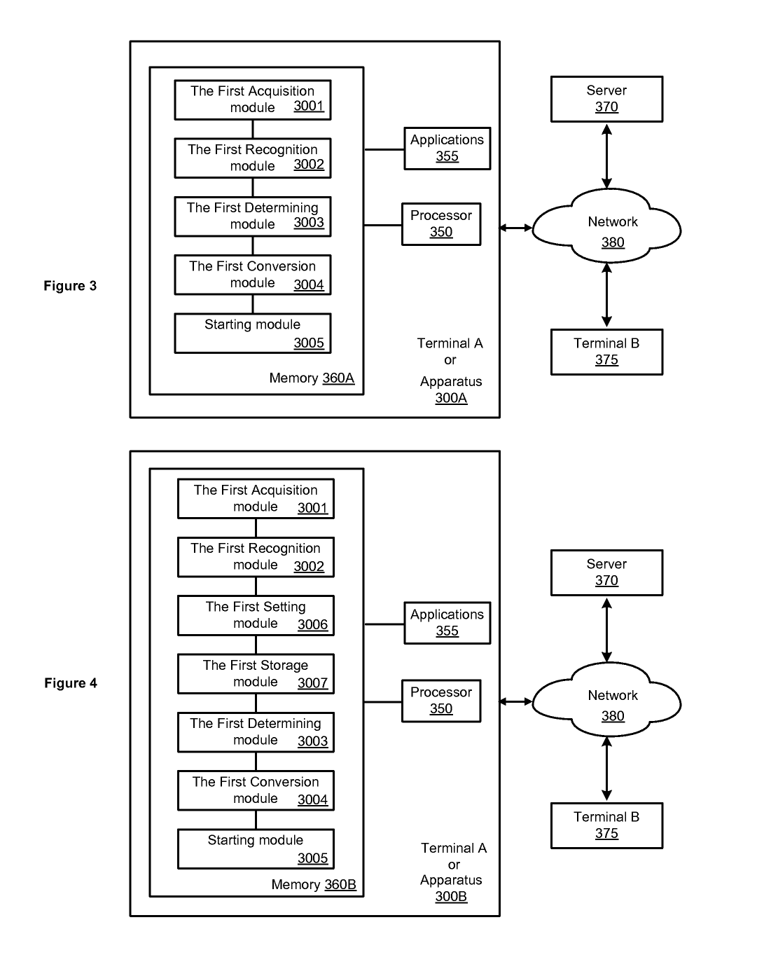

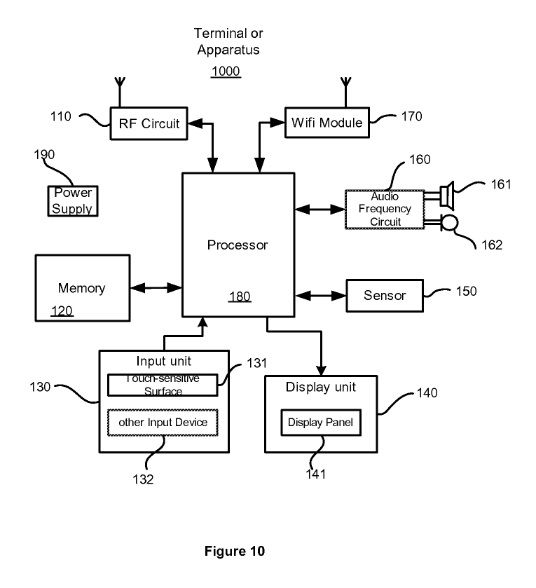

After setting a startup command word for each installed application, it may be needed to store these startup command words. For example, the startup command word of each installed application may be stored in a memory (such as in memory 360A to 360G in FIGS. 3-9 and in memory 120 in FIG. 10). Of course, the startup command word of each installed application may also be stored in a memory card or as cache memory, which should not be limiting in the disclosure.

It should note that after setting and storing the startup command word for each installed application, this step may be bypassed when subsequently executed again, once after the startup command word is updated.

In addition, the determining of whether the first speech recognition result includes the startup command word for the particular installed application which has not been started on the terminal, including: comparing the first recognition result with the stored startup command word of each installed application on the terminal, if the first speech recognition result includes the startup command word of the particular installed application which has not been started, then the first speech recognition result is determined to include the startup command word of the particular installed application.

For example the startup command word of “starting instant messaging application”, may be applicable to an instant messaging application which has been installed but not yet started.

Step 203: if the first speech recognition result includes the startup command word for the particular installed application, then the particular installed application is regarded as a controlled application, and the startup command word is converted into a startup command for the controlled application; and starting the controlled application utilizing the startup command of the controlled application.

In this step, if the startup command word is merely a field as text data, the startup command word in the form of text data format may not be able to be configured to start an application. Therefore, in order to achieve speech command to control an application startup, a correspondence needs to be set between the startup command and the startup command word since a startup command is a machine readable instruction.

Accordingly, prior to the determining of whether the first speech recognition result includes the startup command word for the particular installed application, the method may perform: setting and storing a startup command word of each installed application on the terminal, wherein, the start command may be a string of characters. Table 1 below may illustrate an exemplary correspondence set between a startup command and a startup command word for a particular installed application:

TABLE 1

| startup command word | startup command |
|---|---|
| starting instant messaging | apvgirngphm1233l/ |
| application | |
| starting playing application | Pbiemhguyzsm0/ |

After setting a correspondence between a startup command and a startup command word of each installed application, the correspondence may then be stored in a memory. It should be pointed out that such correspondence set between the startup command and the startup command word may only needs to be executed once after the application has been started, until further update.

In addition, another implementation of the disclosure may include converting of the startup command word into the startup command of the controlled application by: looking up the startup command corresponding to the startup command word of the controlled application in the stored correspondence between the startup command and the startup command word of each installed application, in order to obtain the startup command of the controlled application.

Step 204: starting the controlled application utilizing the startup command of the controlled application. A specific implementation may include opening up a main interface of the controlled application via the startup command of the controlled application and displaying the main interface on the current page of the mobile terminal.

It should be noted that after the starting of the controlled application utilizing the startup command of the controlled application, the method may be applicable to control operation or executing a corresponding input or response through a corresponding speech data, which may be illustrated in the following steps 205 to 208.

Step 205: acquiring a second speech data input by the user, wherein the speech recognition is being performed on the second speech data to obtain a second speech recognition result.

Step 206: determining whether the second speech recognition result includes a functional command word of the controlled application. For example, a functional command word of the controlled application may be: “view circle of friends”, “communicate with XXX”, “important date reminders”, “get real-time news” etc., to name a few.

In addition, in order to achieve controlling the application to respond to its corresponding functions via speech commands, certain corresponding functional command words may be set for each respective installed application on the terminal, such that a determination may be made on whether the second speech recognition result includes a functional command word of the controlled application.

Therefore, prior to the determining of whether the second speech recognition result includes the functional command word for the controlled application, the method also include: setting and storing a functional command word for each of the installed application into a memory.

In addition, the same functions may be applicable to different applications. For example, Application A and Application B may both have the same function of sending short messages. Therefore, a functional command word for sending short messages of Application A and for Application B may both be “sending short messages”. However, such common commands may inadvertently cause a subsequent command for Application A be unintentionally executed on Application B as well.

Therefore, in order to avoid this unintended conflict, when setting the functional command word of each installed application, a specific keyword may be added to the functional command to differentiate between applications. For example, a functional command of “sending short messages by Application A” may be used for Application A, and a functional command of “sending short messages by Application B” may be used for Application B. That way, conversion error may be avoided between applications for similar functional commands in all subsequent steps.

It may be pointed out that after the setting and the storing of the functional command word of each installed application, step 206 may be bypassed for executing subsequent similar steps, until the functional command may be updated again.

The determining of whether the second speech recognition result includes the functional command word of the controlled application, may include: comparing the second speech recognition result with the functional command word of the controlled application, and determining whether the second speech recognition result includes the functional command word of the controlled application according to the comparison result.

Using the same example of the instant messaging (IM) application being the controlled application, and “instant messaging application view circle of friends”, “instant messaging application communicate with XXX”, “important date reminders of instant messaging application” being the functional command words, when comparing the second speech recognition result with the functional command word of the instant messaging application: if the second speech recognition result includes the field “instant messaging application view circle of friends”, it may then be determined that the second speech recognition result may include the functional command word of the instant messaging application, otherwise, the second speech recognition result does not include the functional command word of the instant messaging application.

Step 207: If the second speech recognition result does include the functional command word of the controlled application, then the functional command word of the controlled application is converted into a function command of the controlled application.

Since the functional command word being a field which may be text data, the instant messaging application may not be configured to respond or be controlled by the functional command word in the form of text data. Therefore, in order to achieve speech command controlled operations in the application, it may be necessary to set a correspondence between the function command and the functional command word; such that the function command may be recognized as a machine readable instruction command.

Therefore, prior to the converting of the functional command word of the controlled application into the function command of the controlled application, the method may include: setting and storing a correspondence between the function command and a functional command word of each installed application, wherein the function command may be a string of characters. For example, Table 2 below may illustrate a correspondence set between a function command and a functional command word for an installed instant messaging application:

TABLE 2

| Functional command word | Function command |
|---|---|
| instant messaging application view | Girngphm4862l/ |
| circle of friends | |
| important date reminders of instant | Pbiemhguyzsm0123 |
| messaging application | |

After setting a correspondence between the function command and the functional command word of an installed application, the correspondence may be stored in a memory in advance, until updated. In order to quickly look up the function command which corresponds to the functional command word, the correspondence between the function command and the functional command word of each installed application may be separately stored. For example, each installed application may separately store a respective Table 1 and a Table 2, such that the function command for each installed application may be individually controlled without causing an error in executing subsequent steps.

In addition, the implementation of the converting of the functional command word into the function command of the controlled application, include: looking up the function command corresponding to the functional command word of the controlled application in the stored correspondence between the function command and the functional command word of the controlled application in order to obtain the function command of the controlled application.

Step 208: controlling the controlled application as a response to the function command of the controlled application. In this step, the controlled application may respond to the function command of the controlled application after acquiring the function command of the controlled application. For example, using the example of the controlled application being the instant messaging application, and the function command of the instant messaging application being “view circle of friends”, the instant messaging application may be controlled to open a circle of friends pertaining to the user of terminal A, while dynamically showing messages from friends, and a status of friends.

As seen, in the above disclosure of speech control application startup and function command of controlled application provides improved convenience in user experience.

FIG. 3 illustrates an exemplary structural schematic diagram of an apparatus (300A) or Terminal A for controlling an application (355) and its operations, according to a first embodiment of the disclosure. The apparatus (300A) may include at least a processor (350) operating in conjunction with at least a memory (360A) which stores instruction codes operable as plurality of modules, wherein the plurality of modules may include: a first acquisition module (3001), a first recognition module (3002), a first determining module (3003), a first conversion module (3004) and a starting module (3005). For the sake of brevity, the “applications” (355) block may collectively represent one or more applications, or any particular application mentioned inclusively in the claim language.

The first acquisition module (3001) may acquire a first speech data spoken by a user of the terminal A or apparatus (300A). The first recognition module (3002) may perform speech recognition on the first speech data in order to obtain a first recognition result. The first determining module (3003) may determine whether the first speech recognition result includes a startup command word for a particular installed application (355) which has not been started on a terminal, wherein the particular installed application (355) includes at least a social networking application.

The first conversion module (3004), which: if it is determined by the first determining module (3003) that the first speech recognition result includes the startup command word for the particular installed application (355) has not been started, sets the particular installed application as a controlled application; and converts the startup command word included in the first speech recognition result into a startup command of the controlled application (355). The starting module (3005) starts the controlled application (355) utilizing the startup command of the controlled application.

The apparatus (300A) (or terminal A) may communicate to another terminal B (375), and simultaneously interacting with a server (370) (i.e., web server) through a network (380) (e.g., an Internet).

FIG. 4 illustrates an exemplary structural schematic diagram of an apparatus (300B) for controlling an application and its operations, according to a second embodiment of the disclosure. As seen, the Apparatus (300B) depicted in FIG. 4 is similar to the Apparatus (300A) depicted in FIG. 3 in many aspects, except with the addition of at least a first setting module (3006) and a first storage module (3007). The modules which have previously been described in FIG. 3 may not be described again.

The first storage module (3006) may store the startup command word of each installed application (355) set by the first setting module (3006). The first determining module (3003) may compare the first speech recognition result with the startup command word of each installed application stored by the first storage module. If the first speech recognition result includes the startup command word of the particular installed application which has not been started, then the first speech recognition result is determined to include the startup command word of the particular installed application.

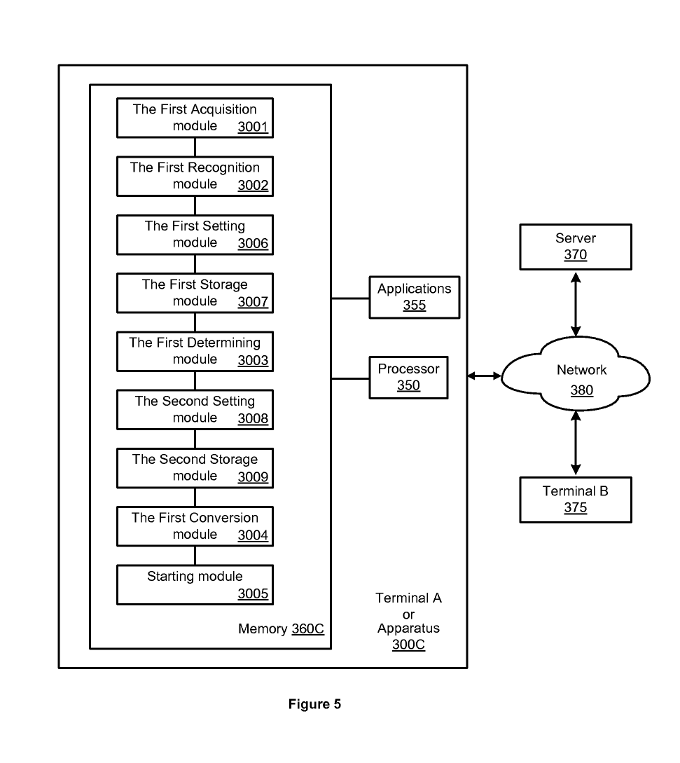

FIG. 5 illustrates an exemplary structural schematic diagram of an apparatus for controlling an application (355) and its operations, according to a third embodiment of the disclosure. The apparatus (300C) in FIG. 5 is similar to the Apparatus (300B) depicted in FIG. 4 in many aspects, except with the addition of at least a second setting module (3008) and a second storage module (3009). The modules which have previously been described in FIG. 4 may not be described again.

The second setting module (3008) may set a correspondence between the startup command and the startup command word of each installed application (355).

The second storage module (3009) may store the correspondence between the startup command and the startup command word of each installed application (355) set by the second setting module (3008).

The first conversion module (3004) may look up the startup command corresponding to the startup command word of the controlled application (355) in the stored correspondence between the startup command and the startup command word of each installed application (355), in order to obtain the startup command of the controlled application (355).

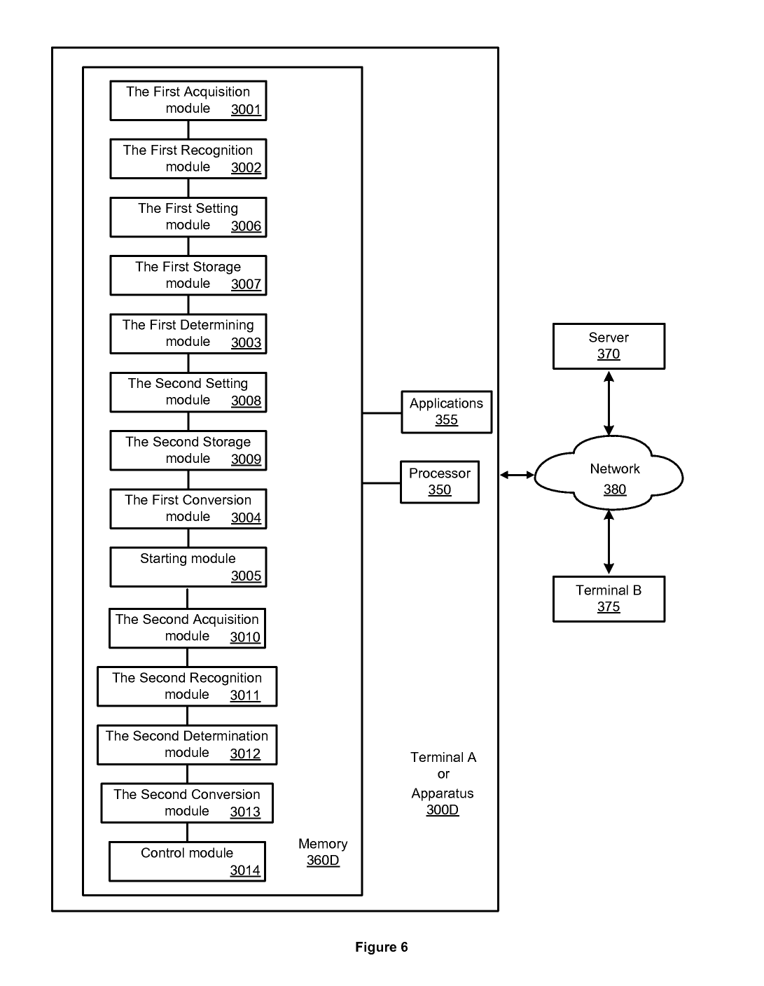

FIG. 6 illustrates an exemplary variant structural schematic diagram of an apparatus as depicted in FIG. 5, according to another embodiment of the disclosure. The apparatus (300D) in FIG. 6 is similar to the Apparatus (300C) depicted in FIG. 5 in many aspects, except with the addition of at least a second acquisition module (3010), a second recognition module (3011), a second determination module (3012), a second conversion module (3013) and a control module (3014). The modules which have previously been described in FIG. 5 may not be described again.

The second acquisition module (3010) may acquire a second speech data input by the user, wherein the speech recognition is being performed on the second speech data to obtain a second speech recognition result.

The second recognition module (3011) may perform speech recognition on the second speech data acquired by the second acquisition module (3010) in order to obtain the second recognition result.

The second determining module (3012) may determine whether the second speech recognition result includes a functional command word of the controlled application.

The second conversion module (3013), which If the second speech recognition result does include the functional command word of the controlled application, may convert the functional command word of the controlled application into a function command of the controlled application.

The control module (3014) may control the controlled application as a response to the function command of the controlled application.

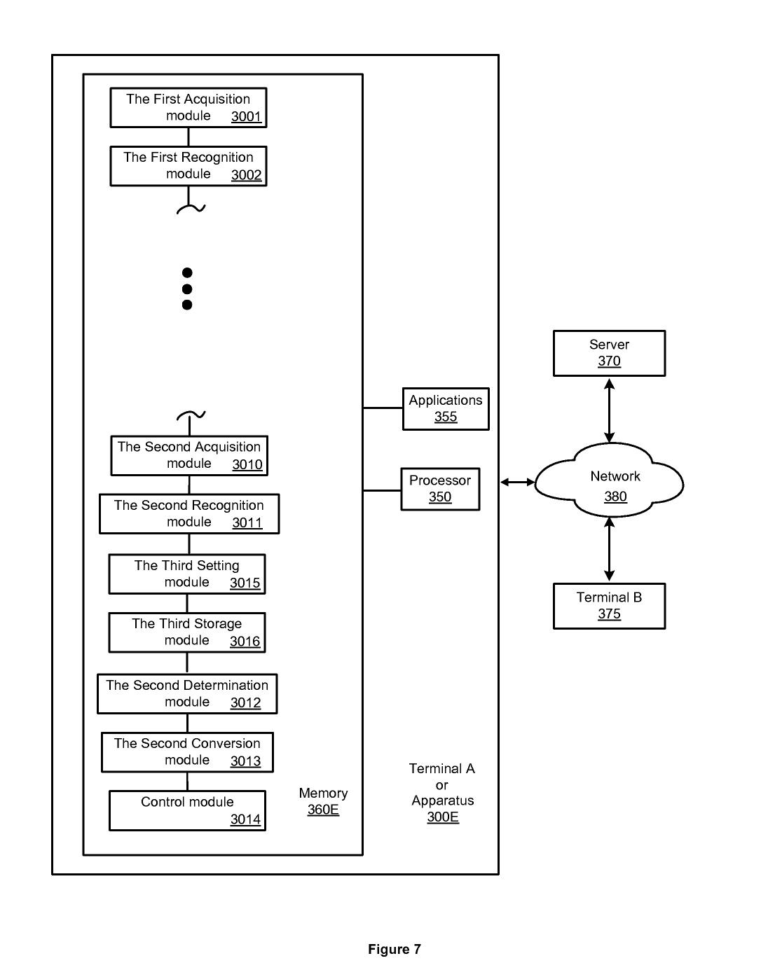

FIG. 7 illustrates an exemplary variant structural schematic diagram of an apparatus as depicted in FIG. 6, according to yet another embodiment of the disclosure. The apparatus (300E) in FIG. 7 is similar to the Apparatus (300D) depicted in FIG. 6 in many aspects, except with the addition of at least a third setting module (3015) and a third storage module (3016), The modules which have previously been described in FIG. 6 may not be described again.

The third setting module (3015) may set a functional command word for each of the installed application (355).

The third storage module (3016) may store the functional command word of each of the installed application (355) set by the third setting module (3015).

The second determining module (3012) may compare the second speech recognition result with the functional command word of the controlled application, and determining whether the second speech recognition result includes the functional command word of the controlled application (355) according to the comparison result.

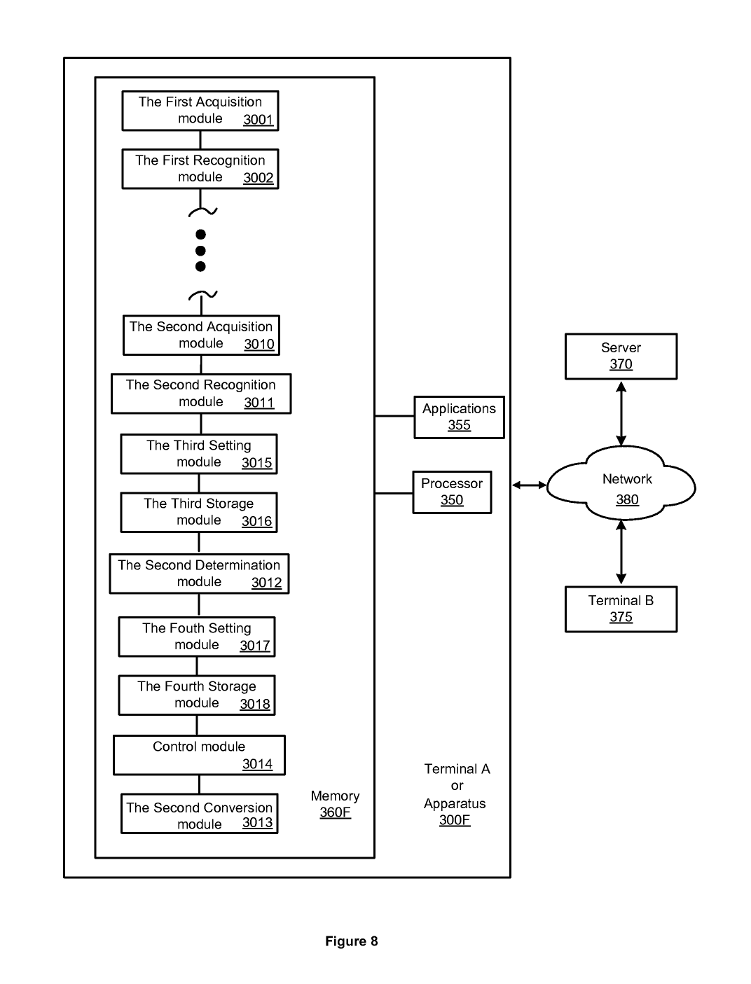

FIG. 8 illustrates an exemplary variant structural schematic diagram of an apparatus as depicted in FIG. 7, according to yet another embodiment of the disclosure. The apparatus (300F) in FIG. 8 is similar to the Apparatus (300E) depicted in FIG. 7 in many aspects, except with the addition of at least a fourth setting module (3017) and a fourth storage module (3018), The modules which have previously been described in FIG. 7 may not be described again.

The fourth setting module (3017) may set a correspondence between the function command and a functional command word of each installed application (355).

The fourth storage module (3018) may store the correspondence between the function command and the functional command word of each installed application set by the fourth setting module (3017).

The second conversion module (3013) may look up the function command corresponding to the functional command word of the controlled application (355) in the stored correspondence between the function command and the functional command word of the controlled application in order to obtain the function command of the controlled application.

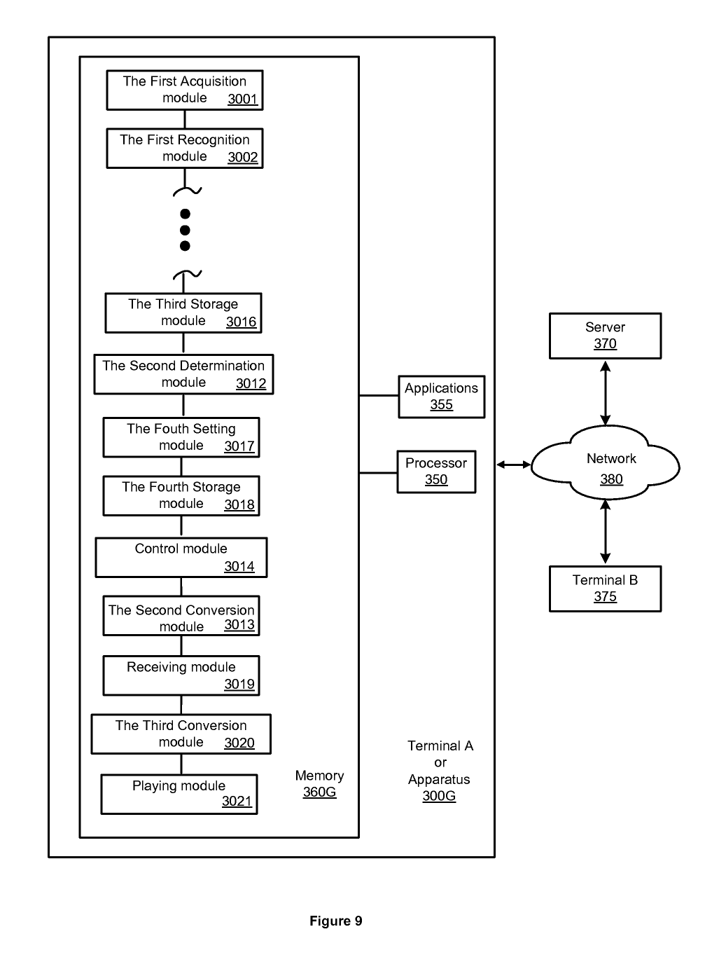

FIG. 9 illustrates an exemplary variant structural schematic diagram of an apparatus as depicted in FIG. 8, according to yet another embodiment of the disclosure. The apparatus (300G) in FIG. 9 is similar to the Apparatus (300F) depicted in FIG. 8 in many aspects, except with the addition of at least a receiving module (3019), a third conversion module (3020) and a playing module (3021), The modules which have previously been described in FIG. 8 may not be described again.

The receiving module (3019) may receive as an input from another user (i.e., terminal B (375)), a text data pertaining to the controlled application (355).

The third conversion module (3020) may convert the text data pertaining to the controlled application (355) into a corresponding speech data utilizing known text to speech conversion algorithms or application.

The playing module (3021) may play to the user the converted speech data as an audible signal.

FIG. 10 illustrate an exemplary structural schematic diagram of a terminal (1000), according to an embodiment of the disclosure. The schematic of terminal (1000) may be implemented in anyone of the disclosed apparatuses (300A to 300G) as depicted in FIGS. 3 to 9.

As shown in FIG. 10, the Terminal (1000) may include at least: a RF (Radio Frequency) Circuit (110), a Memory (120) which may include one or more non-transitory computer readable storage medium, an Input unit (130), a Display unit (140), a Sensor (150), an Audio Frequency Circuit (160), a WiFi (wireless fidelity) Module (170), a Processor (180) which may include one or more processing cores and a Power Supply (190) etc. A person skilled in the art recognizes that the terminal (1000) is not limited to its structure shown in FIG. 10, it may include more or less components than the components depicted in the Figure, or their equivalence or in any combinations

The RF Circuit 110 may receive and transmit RF signals during a call or sending and receiving information. More specifically, the RF Circuit (110) may receive downlink information from a base station and submit information to one or more Processor (180) for processing. Additionally, the RF Circuit (110) may send data related to the uplink to the base station. Generally, the RF Circuit (110) may include an antenna, at least one amplifier, a tuner, one or more oscillators, User Identity Module (SIM) card, transceiver, coupler, LNA (Low Noise Amplifier) and duplexer, etc. In addition, the RF Circuit (110) may also communicate with other equipment (e.g., terminal B (375) or server (370)) via wireless communications and a network (380). The wireless communication may use any communication standard or protocol, including but not limited to GSM (Global System of Mobile communication), GPRS (General Packet Radio Service), CDMA (Code Division Multiple Access), WCDMA (Wideband Code Division Multiple Access), LTE (Long Term Evolution), e-mail, SMS (Short Messaging Service), etc.

The Memory (120) stores software programs and at least the various disclosed modules, The Processor (180) may run software programs stored in the modules in the memory (120), perform various functions from the applications and process data. The memory (120) may include programs storage area and data storage area, wherein the programs storage area may store the operating system and at least one application with multimedia functions (e.g. sound playback function and image playback function, etc.), etc. The data storage area for storing the generated data (e.g. audio data and phone book, etc.) may depend on the use of the Terminal (1000). In addition, the memory (120) may include high-speed random access memories (RAM), non-volatile memory (ROM), e.g. at least one disk storage device, flash memory devices, or other volatile solid state memory devices. Accordingly, memory (120) may also include a memory controller for providing access to memory (120) by the Processor (180) and the Input unit (130).

The Input unit 130 may receive entered numbers or characters information, and generate keyboard, mouse, joystick and optical or trackball signal input related to user settings and functions control. More specifically, the Input unit (130) may include a Touch-sensitive Surface (131) and other Input Device (132). The Touch-sensitive Surface (131) may also be referred to as touch display screen or touch pad, for collecting the touch operations on or near the screen or pad (e.g. the operations on or near the Touch-sensitive Surface (131) by suitable objects or accessories such as user fingers, stylus etc.), and driving corresponding connecting devices based on the preset programs. Optionally, the Touch-sensitive Surface (131) may include two parts, a touch detection device and a touch controller. Wherein the touch detection device for detecting the user's locations and the signal brought by touch operations, and transmitting the signal to the touch controller. The touch controller may receive touch information from the touch detection device and transform the signals into contact coordinates which will be sent to the Processor (180), and receive and execute the commands from the Processor (180).

In addition, the Touch-sensitive Surface (131) may be achieved by using several kinds of acoustic waves e.g. resistive, capacitive, infrared and surface acoustic waves. The Input unit (131) may also include other Input Device (132) other than the Touch-sensitive Surface (131). Other Input Device (132) may include but not limited to one or more of physical keyboards, function keys (e.g. volume control buttons, switch keys, etc.), trackballs, mouse, joysticks, etc.

The Display unit (140) for displaying the information entered by the user. The information supplied to the user or a variety of graphical user interfaces (GUI) of the Terminal (1000); graphics, texts, icons, videos and any combination of them may constitute as graphical user interfaces. The Display unit 140 may include a Display Panel (141) which may be configured optionally with LCD (Liquid Crystal Display), OLED (Organic Light-Emitting Diode) etc.

Furthermore, the Display Panel (141) may cover Touch-sensitive Surface (131), when the Touch-sensitive Surface (131) detects touch operations on or near itself, it may send signals to the Processor (180) to determine the type of the touch event, then the Processor (180) may provide corresponding visual outputs on the Display Panel (141), depending on the type of the touch event.

The Terminal (1000) may also include a Sensor (150). For example, the sensor (150) may include at least optical sensors, motion sensors and other sensors. Specifically, the optical sensor may include an ambient light sensor and a proximity sensor, wherein, the ambient light sensor can adjust the brightness of the Display Panel (141) according to the ambient light and darkness, a proximity sensor can turn off Display Panel (141) and/or backlight when the Terminal (1000) is moved to the ear. A Gravity acceleration sensor is a motion sensor, which detects a magnitude of acceleration in all directions (generally triaxial), and detect the magnitude and direction of gravity when it is stationary. The sensor (150) may include mobile phone posture applications (e.g. switch the screen anyway, related games and magnetometer posture calibration) and vibration recognition related functions (e.g. pedometers and percussions), etc.; as to the gyroscope, barometer, hygrometer, thermometer, infrared sensors and other sensors which may also supplied on the Terminal 1000 are need not be repeated here.

The Audio Circuit (160) may include a Speaker (161) and a microphone (162) may provide an audio interface between the user and the Terminal (1000). The Audio Circuit (160) may convert the received audio data into an electrical signal to be transmitted to the Speaker (161), Electrical signals may be converted into a sound signal output; On the other hand, the collected sound signal may be converted into electrical signals by Speaker (162), The Audio Circuit (160) may receive the electrical signals and converts them into audio data which may be exported to the Processor (180) for processing and transmitted to another terminal via the RF Circuit (110) or exported to memory (120) for further processing. The Audio Circuit (160) may also include earplug jack to provide communication between the peripheral headset and the Terminal (1000).

WiFi is a technology of short range wireless transmission, the Terminal (1000) can help users to send and receive email, browse the web and access streaming media etc. via the WiFi Module (170), provide users with wireless broadband Internet access.

The Processor (180) may be a control center of the Terminal (1000), for using a variety of interfaces and lines to connect various parts throughout a mobile phone, and executing various functions of the Terminal (1000) and processing data by running or executing software programs and/or modules stored in memory (120) and calling the data stored in memory (120), to achieve the overall control of the mobile phone. Optionally, the Processor (180) may include one or more processing cores; preferably, the Processor (180) may be integrated with an application processor and a modem processor, wherein the application processor is mainly used to process operating system, user interface and applications etc. A modem processor may be used to process wireless communications. It can be understood that the modem processor may not be integrated into Processor 180.

The Terminal (1000) may also include a Power Supply (190) (e.g. a battery) which powers the various components, preferably, the power supply can achieve logic connection with the Processor (180) via the power supply management system, and thus achieving functions such as charging, discharging and power consumption management via the power supply management system. Power Supply (190) may also include one or more power sources such as a DC supply or an AC power supply, recharging system, power supply failure detection circuit, power supply converter or inverter and power supply status indicator etc.

Although not shown in FIG. 10, the Terminal (1000) may also include a camera, a Bluetooth module etc., which need not be described here. Specifically in this embodiment, the display unit of the terminal is a touch display screen, the terminal also includes memories and one or more programs, wherein the one or more programs are stored in the memories and will be executed by one or more processors after configured, in which the commands for following operations are included:

In another embodiment, the steps disclosed in the method may be implemented as computer codes stored on a non-transitory computer readable storage medium, executable by a machine, such as a terminal or a computer to carry out the functions recited in the method claims, which may not be repeated again.

In another embodiment, the recited functions in the method claims of the disclosure may be implemented using a graphical user interface on a touch screen display of a terminal.

It should be understood by those with ordinary skill in the art that all or some of the steps of the foregoing embodiments may be implemented by hardware, or software program codes stored on a non-transitory computer-readable storage medium with computer-executable commands stored within. For example, the disclosure may be implemented as an algorithm as codes stored in a program module or a system with multi-program-modules. The computer-readable storage medium may be, for example, nonvolatile memory such as compact disc, hard drive. ROM or flash memory. The computer-executable commands are used to enable a computer, server, a smart phone, a tablet or any similar computing device to render using speech to control to an application startup and its operations on a terminal.

The sequence numbers of the above embodiments of the disclosure are only for the purpose of description, and do not represent one embodiment is superior to another.

The foregoing represents only some preferred embodiments of the present disclosure and their disclosure cannot be construed to limit the present disclosure in any way. Those of ordinary skill in the art will recognize that equivalent embodiments may be created via slight alterations and modifications using the technical content disclosed above without departing from the scope of the technical solution of the present disclosure, and such summary alterations, equivalent has changed and modifications of the foregoing embodiments are to be viewed as being within the scope of the technical solution of the present disclosure.

What is claimed is:

1. A method for controlling an application startup and its functions, comprising:
acquiring a first speech data input by a user, wherein speech recognition is being performed on the first speech data to obtain a first speech recognition result;
determining whether the first speech recognition result includes a startup command word for a particular installed application which has not been started on a terminal, wherein the particular installed application includes at least a social networking application;
if the first speech recognition result includes the startup command word for the particular installed application, then the particular installed application is regarded as a controlled application, and the startup command word is converted into a startup command for the controlled application; and
starting the controlled application utilizing the startup command of the controlled application.

2. The method according to claim 1, comprising prior to the determining of whether the first speech recognition result includes the startup command word for the particular installed application, the method performing:
setting and storing a startup command word of each installed application on the terminal;
wherein the determining of whether the first speech recognition result includes the startup command word for the particular installed application which has not been started on the terminal, comprising:
comparing the first recognition result with the stored startup command word of each installed application on the terminal, if the first speech recognition result includes the startup command word of the particular installed application which has not been started, then the first speech recognition result is determined to include the startup command word of the particular installed application.

3. The method according to claim 1, comprising prior to converting the startup command word into the startup command for the controlled application, the method performing:
setting and storing a correspondence between the startup command and the startup command word for each installed application;
wherein the converting of the startup command word into the startup command of the controlled application, comprising:
looking up the startup command corresponding to the startup command word of the controlled application in the stored correspondence between the startup command and the startup command word of each installed application, in order to obtain the startup command of the controlled application.

4. The method according to claim 1, wherein after the starting of the controlled application utilizing the startup command of the controlled application, the method comprising:
acquiring a second speech data input by the user, wherein the speech recognition is being performed on the second speech data to obtain a second speech recognition result;
determining whether the second speech recognition result includes a functional command word of the controlled application;
If the second speech recognition result does include the functional command word of the controlled application, then the functional command word of the controlled application is converted into a function command of the controlled application; and
controlling the controlled application as a response to the function command of the controlled application.

5. The method according to claim 4, wherein prior to the determining of whether the second speech recognition result includes the functional command word for the controlled application, the method also comprising:
setting and storing a functional command word for each of the installed application;
wherein the determining of whether the second speech recognition result includes the functional command word of the controlled application, comprising:
comparing the second speech recognition result with the functional command word of the controlled application, and determining whether the second speech recognition result includes the functional command word of the controlled application according to the comparison result.

6. The method according to claim 4, wherein prior to the converting of the functional command word of the controlled application into the function command of the controlled application, the method comprising:
setting and storing a correspondence between the function command and a functional command word of each installed application;
wherein the converting of the functional command word into the function command of the controlled application, comprising:
looking up the function command corresponding to the functional command word of the controlled application in the stored correspondence between the function command and the functional command word of the controlled application in order to obtain the function command of the controlled application.

7. The method according to claim 1, wherein after the starting of the controlled application utilizing the startup command of the controlled application, the method comprising:
receiving as an input from another user, a text data pertaining to the controlled application;
converting the text data pertaining to the controlled application into a corresponding speech data utilizing known text to speech conversion application; and
playing to the user the converted speech data as an audible signal.

8. An apparatus for controlling an application startup and its functions, comprising at least a processor with circuitry operating in conjunction with at least a memory which stores instruction codes operable as plurality of modules, wherein the plurality of modules comprise:
a first acquisition module which acquires a first speech data;
a first recognition module which performs speech recognition on the first speech data in order to obtain a first recognition result;
a first determining module which determines whether the first speech recognition result includes a startup command word for a particular installed application which has not been started on the apparatus, wherein the particular installed application includes at least a social networking application;
a first conversion module, which:
if it is determined by the first determining module that the first speech recognition result includes the startup command word for the particular installed application has not been started, sets the particular installed application as a controlled application; and converts the startup command word included in the first speech recognition result into a startup command of the controlled application; and
a starting module which starts the controlled application utilizing the startup command of the controlled application.

9. The apparatus according to claim 8, further comprises:
a first setting module, which sets a startup command word of each installed application on the terminal;
a first storage module, which stores the startup command word of each installed application set by the first setting module; and
the first determining module, which compares the first speech recognition result with the startup command word of each installed application stored by the first storage module;
if the first speech recognition result includes the startup command word of the particular installed application which has not been started, then the first speech recognition result is determined to include the startup command word of the particular installed application.

10. The apparatus according to claim 8, further comprises:
a second setting module, which sets a correspondence between the startup command and the startup command word of each installed application;
a second storage module, which stores the correspondence between the startup command and the startup command word of each installed application set by the second setting module; and
the first conversion module, which looks up the startup command corresponding to the startup command word of the controlled application in the stored correspondence between the startup command and the startup command word of each installed application, in order to obtain the startup command of the controlled application.

11. The apparatus according to claim 8, further comprises:
a second acquisition module, which acquires a second speech data input by the user, wherein the speech recognition is being performed on the second speech data to obtain a second speech recognition result;
a second recognition module, which performs speech recognition on the second speech data acquired by the second acquisition module in order to obtain the second recognition result;
a second determining module, which determines whether the second speech recognition result includes a functional command word of the controlled application;
a second conversion module, which If the second speech recognition result does include the functional command word of the controlled application, converts the functional command word of the controlled application into a function command of the controlled application; and
a control module, which controls the controlled application as a response to the function command of the controlled application.

12. The apparatus according to claim 11, further comprises:
a third setting module, which sets a functional command word for each of the installed application;
a third storage module, which stores the functional command word of each of the installed application set by the third setting module; and
a second determining module, which compares the second speech recognition result with the functional command word of the controlled application, and determining whether the second speech recognition result includes the functional command word of the controlled application according to the comparison result.

13. The apparatus according to claim 11, further comprises:
a fourth setting module, which sets a correspondence between the function command and a functional command word of each installed application;
a fourth storage module, which stores the correspondence between the function command and the functional command word of each installed application set by the fourth setting module; and
a second conversion module, which looks up the function command corresponding to the functional command word of the controlled application in the stored correspondence between the function command and the functional command word of the controlled application in order to obtain the function command of the controlled application.

14. The apparatus according to claim 8, further comprises:
a receiving module, which receives as an input from another user, a text data pertaining to the controlled application;
a third conversion module, converts the text data pertaining to the controlled application into a corresponding speech data utilizing known text to speech conversion application; and
a playing module, plays to the user the converted speech data as an audible signal.

15. A non-transitory computer-readable medium having stored thereon, a computer program having at least one code section being executable by a machine which causes the machine to perform steps for controlling an application startup and its functions, comprising:
acquiring a first speech data input by a user, wherein speech recognition is being performed on the first speech data to obtain a first speech recognition result;
determining whether the first speech recognition result includes a startup command word for a particular installed application which has not been started on a terminal, wherein the particular installed application includes at least a social networking application;
if the first speech recognition result includes the startup command word for the particular installed application, then the particular installed application is regarded as a controlled application, and the startup command word is converted into a startup command for the controlled application; and
starting the controlled application utilizing the startup command of the controlled application.

16. The non-transitory computer-readable medium according to claim 15, comprising prior to the determining of whether the first speech recognition result includes the startup command word for the particular installed application, the method performing:
setting and storing a startup command word of each installed application on the terminal;
wherein the determining of whether the first speech recognition result includes the startup command word for the particular installed application which has not been started on the terminal, comprising:
comparing the first recognition result with the stored startup command word of each installed application on the terminal, if the first speech recognition result includes the startup command word of the particular installed application which has not been started, then the first speech recognition result is determined to include the startup command word of the particular installed application.

17. The non-transitory computer-readable medium according to claim 15, comprising prior to converting the startup command word into the startup command for the controlled application, the method performing:
setting and storing a correspondence between the startup command and the startup command word for each installed application;
wherein the converting of the startup command word into the startup command of the controlled application, comprising:
looking up the startup command corresponding to the startup command word of the controlled application in the stored correspondence between the startup command and the startup command word of each installed application, in order to obtain the startup command of the controlled application.

18. The non-transitory computer-readable medium according to claim 15, wherein after the starting of the controlled application utilizing the startup command of the controlled application, the method comprising:
acquiring a second speech data input by the user, wherein the speech recognition is being performed on the second speech data to obtain a second speech recognition result;
determining whether the second speech recognition result includes a functional command word of the controlled application;
If the second speech recognition result does include the functional command word of the controlled application, then the functional command word of the controlled application is converted into a function command of the controlled application; and
controlling the controlled application as a response to the function command of the controlled application.

19. The non-transitory computer-readable medium according to claim 18, wherein prior to the determining of whether the second speech recognition result includes the functional command word for the controlled application, the method also comprising:
setting and storing a functional command word for each of the installed application;
wherein the determining of whether the second speech recognition result includes the functional command word of the controlled application, comprising:
comparing the second speech recognition result with the functional command word of the controlled application, and determining whether the second speech recognition result includes the functional command word of the controlled application according to the comparison result.

20. The non-transitory computer-readable medium according to claim 18, wherein prior to the converting of the functional command word of the controlled application into the function command of the controlled application, the method comprising:
setting and storing a correspondence between the function command and a functional command word of each installed application;
wherein the converting of the functional command word into the function command of the controlled application, comprising:
looking up the function command corresponding to the functional command word of the controlled application in the stored correspondence between the function command and the functional command word of the controlled application in order to obtain the function command of the controlled application.

21. The non-transitory computer-readable medium according to claim 15, wherein after the starting of the controlled application utilizing the startup command of the controlled application, the method comprising:
receiving as an input from another user, a text data pertaining to the controlled application;
converting the text data pertaining to the controlled application into a corresponding speech data utilizing known text to speech conversion application; and
playing to the user the converted speech data as an audible signal.
